(19) United States
(12) Patent Application Publication
(10) Pub. No.: US 2009/0127039 A1
(43) Pub. Date: May 21, 2009

(54) Vibration Damper

(75) Inventors: Bernd Zeissner, Volkach/Gaibach (DE); Andreas Foerster, Schweinfurt (DE); Frank Gundermann, Marktsteinach (DE); Steffen Heyn, Niederwerrn (DE); Anton Krawczyk, Windeck (DE); Uwe Boecker, Lohmar (DE); Thomas Thein, Sennfeld (DE); Wolfgang Breun, Niederwerrn (DE); Herbert Bies, Grafschaft/Vettelhoven (DE); Holger Beyer, Pfarrweisach (DE); Ludwig Gampl, Schwanfeld (DE); Heinz-Joachim Gilsdorf, Donnersdorf (DE); Klaus Sauer, Roethlein (DE)

Correspondence Address: COHEN, PONTANI, LIEBERMAN & PAVANE LLP, 551 FIFTH AVENUE, SUITE 1210, NEW YORK, NY, 10176, US

(73) Assignee: ZF FRIEDCHSHAFEN AG, FRIEDRICHSHAFEN (DE)

(21) Appl. No.: 11/990,239

(22) PCT Filed: Aug. 18, 2006
(86) PCT No.: PCT/EP2006/008158

§ 371 Date: Feb. 8, 2008

(30) Foreign Application Priority Data
Aug. 24, 2005 (DE) 10-2005-040-284.4

(51) Int. Cl. F16F 9/512

(52) U.S. Cl. 188/266.5

(57) ABSTRACT

Disclosed is a vibration damper comprising a cylinder in which a piston rod is guided in an axially movable manner. A first piston (7) is mounted stationarily on the piston rod while a second piston (23) that is equipped with at least one valve disk biased by a spring assembly is mounted on the piston rod so as to be axially movable counter to the force of at least one support spring. The spring assembly is provided with at least one spring plate (39, 41) on which the spring assembly (33, 35) rests. The second piston (23) forms a structural unit along with a fixing sleeve (37) and the at least one spring plate for the spring assembly. The at least one spring plate is mounted in an axially movable manner relative to the fixing sleeve (37) and can be fixed in the desired axial position in order to adjust the bias of the spring assembly.

### TECHNICAL AREA

The invention pertains to a vibration damper according to the introductory clause of claim 1.

### PRIOR ART

The vibration damper which represents the prior art is known from DE 100 41 199 C1. This design principle fulfills the function of filtering out high-frequency, low-amplitude excitations and thus offers a comfort advantage over conventional vibration dampers. A first piston is fastened permanently to the piston rod. The second piston slides on the piston rod and is supported by two springs. One of these support springs rests against the first piston, whereas the second support spring rests against a spring plate, which is held in turn by a lock washer. The support springs pretension the valve disks against the second piston and also oppose the axial movement of the second piston. This design requires a complicated assembly procedure and also means that the pretension of the valve disks depends on the axial force which supports the second piston.

A vibration damper with a cylinder in which a piston rod is guided with freedom of axial movement is known from JP 10-339 345 A. A first piston is fastened permanently to the first piston rod, and a second piston is mounted with a certain freedom of movement in the axial direction. The second piston has elastic valve disks and can shift axially against the elastic force of springs. The cylinder has a working space on the piston rod side of the first piston, another working space on the side of the first piston opposite the piston rod, and a working space between the two pistons. Valve-equipped through-openings control the connection between the working spaces. This design also fails to provide a structural unit which can be preassembled for the second piston with its springs.

### PRESENTATION OF THE INVENTION

The task of the present invention is to improve the vibration damper of the general type in question in such a way that the second piston can be easily assembled and also so that the pretension of the valve disks is independent of the axial forces of the support springs.

The task is accomplished according to the invention in that the second piston, a retaining sleeve, and the minimum of one spring plate for the spring arrangement together form a structural unit, where the minimum of one spring plate is supported with freedom of axial movement with respect to the retaining sleeve so that the pretension of the spring arrangement can be adjusted, whereupon the spring plate can be fixed in the desired axial position.

The great advantage is not only that an easy-to-manage structural unit including the second piston is provided but also that the spring arrangement can be adjusted effectively to provide the second piston with the desired damping force characteristic.

According to an advantageous subclaim, the minimum of one spring plate and the retaining sleeve form a press-fit with each other. In comparison to a threaded joint, this offers a considerable advantageous with respect to cost and assembly work, especially because there is no need to take any measures to lock the thread. The press-fit is not required to absorb any especially large axial forces, because only the damping force of the second piston needs to be supported. It is also possible to allow the support springs to rest externally, with respect to the structural unit, against the minimum of one spring plate, so that they can accept a large portion of the axial force acting on the spring plate.

In one embodiment, the retaining sleeve has an end stop, acting in the pull-out direction, for a spring plate, which is pretensioned by the spring arrangement of the second piston against this end stop. It is possible, for example, for one end of the retaining sleeve to have an angled section extending at least part of the way around its circumference.

The outside diameter of the retaining sleeve is provided with several graduations, and one of these graduations forms a press-fit with the second piston. For cost reasons, it is advisable to use a retaining sleeve which is drawn, not machined, and, because of the graduations of its diameter, any deviations in the shape of the retaining sleeve will be less pronounced than they would be otherwise.

It is also possible for the spring plate to be designed as an integral part of the retaining sleeve. The adjustability of the spring arrangement is easily achieved by an axial displacement of the retaining sleeve with respect to the second piston.

In another advantageous variant, the retaining sleeve comprises at least two axially adjacent retaining sleeve parts, where at least one spring plate is designed as an integral part of one of these retaining sleeve parts.

The minimum of two retaining sleeve parts overlap each other axially. To adjust the spring arrangements, the minimum of two retaining sleeve parts are simply pushed into each other to a greater or lesser degree, where, according to an advantageous subclaim, the minimum of two retaining sleeve parts form a press-fit with each other.

Another embodiment is characterized in that the second piston is designed to form a one-piece unit with the retaining sleeve or a retaining sleeve part.

### SHORT DESCRIPTION OF THE DRAWINGS

The invention is to be explained in greater detail below on the basis of the following description of the figures:

FIG. 1 shows a piston rod with a first piston and the inventive structural unit with the second, axially movable piston;

FIG. 2 shows the structural unit according to FIG. 1 in isolation;

FIGS. 3-5 show alternative embodiments of a structural unit with a one-piece retaining sleeve; and

FIGS. 6-7 show structural units with retaining sleeves with multiple axially adjacent parts.

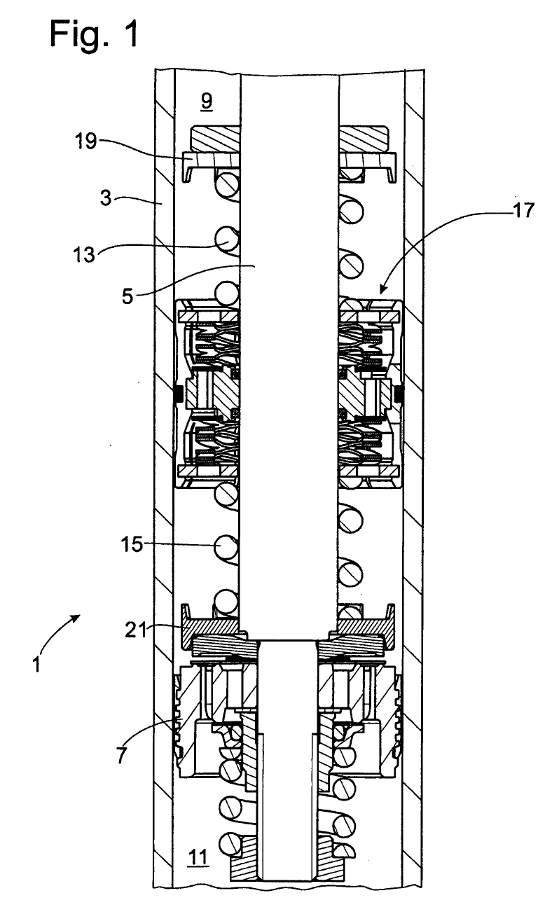

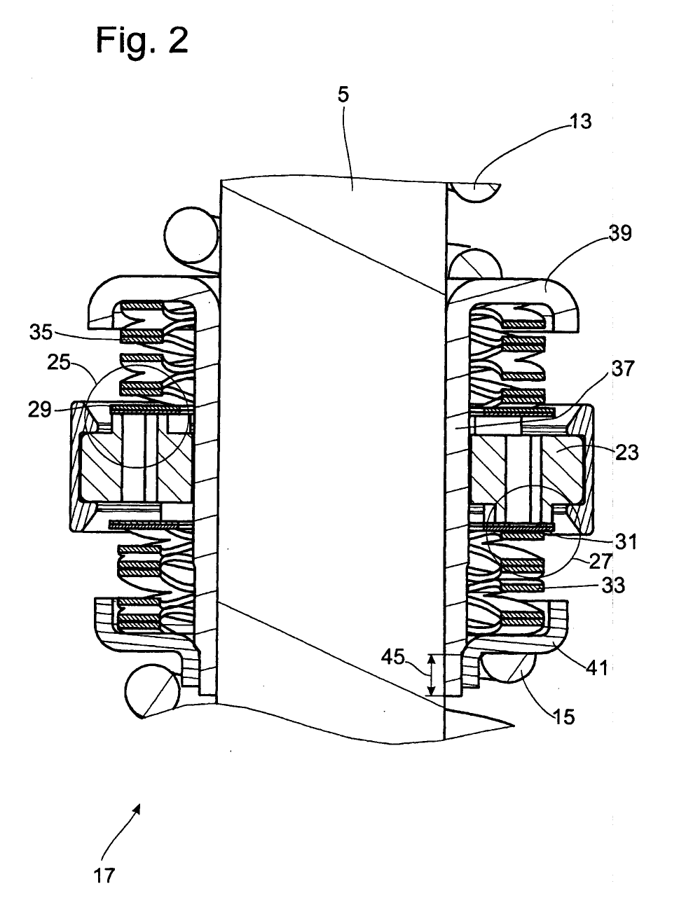

FIG. 1 shows part of a vibration damper 1 with a damping medium-filled cylinder 3, in which a piston rod 5 is guided with freedom of axial movement. A first piston 7 is fastened in place axially to the piston rod 5. This piston 7 divides the cylinder into a working space 9 on the piston rod-side of the piston and a working space 11 on the side of the piston opposite the piston rod. The design an function of the piston 7 are generally known. For additional information, see DE 34 45 684 A1, FIG. 2, the disclosure of which is intended to be part of this description of the figures.

In the piston-rod side working space 9, two support springs 13, 15 are mounted on the piston rod 5. The support forces of these springs act in opposite directions on a structural unit 17, which is shown in isolation in FIG. 2. An end surface of each support spring 13, 15 rests against a support disk 19, 21, which is stationary with respect to the piston rod 5. When the piston rod moves, the structural unit 17 can shift axially with respect to the first piston 7 against the forces of the support springs 13, 15.

FIG. 2 shows the structural unit 17, which has a second piston 23. The second piston 23 has damping valves 25, 27 with valve disks 29, 31, each of which is pretensioned by a spring arrangement 33, 35 in the form of wave washers. The number and form of the springs of the spring arrangements 33, 35 can be different from that shown in FIG. 2 if desired.

The second piston is held by a retaining sleeve 37, each end of which carries a spring plate 39, 41 for the spring arrangements 33, 35. There is a press-fit between the retaining sleeve 37 and the circular ring-shaped piston 23. At the end facing the support spring 13, the retaining sleeve 39 forms a one-piece unit with the spring plate 39. Proceeding from the outside diameter where the retaining sleeve 37 forms a press-fit with the piston, the sleeve has several graduations and forms a press-fit with the spring plate 41.

During the assembly procedure, the spring arrangement 35 together with at least one valve disk 29 is threaded onto the retaining sleeve 37. Then the second piston 23 is pushed onto the retaining sleeve, and the displacement distance is adjusted in such a way that the spring arrangement 35 exerts the desired spring force. Next, the valve disk 31 and the spring arrangement 33 are added. In the final step, the spring plate 41 is pushed onto the retaining sleeve 37, until the spring arrangement 33 also has the correct pretension. The retaining sleeve has a stepped section with a displacement distance 45, which is greater than the axial dimension of the spring plate on the retaining sleeve.

The press-fit between the spring plate 41 and the retaining sleeve 37 does not have to absorb especially strong axial forces proceeding from the spring arrangement 33, because the end of the support spring 15 rests against the spring plate 41.

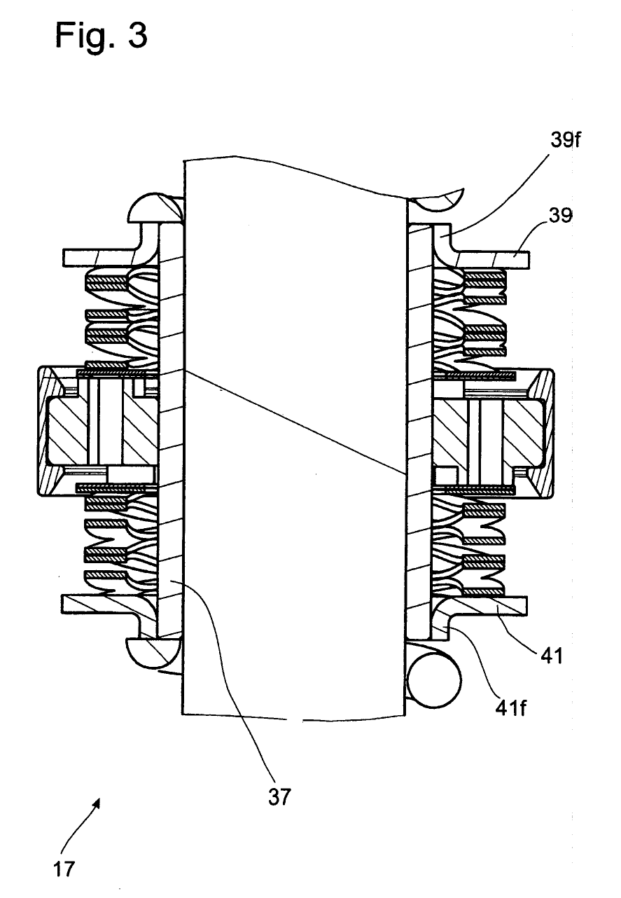

In the variant according to FIG. 3, two spring plates 39, 41 are installed as mirror images of each other within the structural unit 17. When cut in half, each half shows an angled cross section. The guide sections 39f, 41f of the spring plates form press-fits with the retaining sleeve 37. An additional securing function can be provided, if desired, by means of welding.

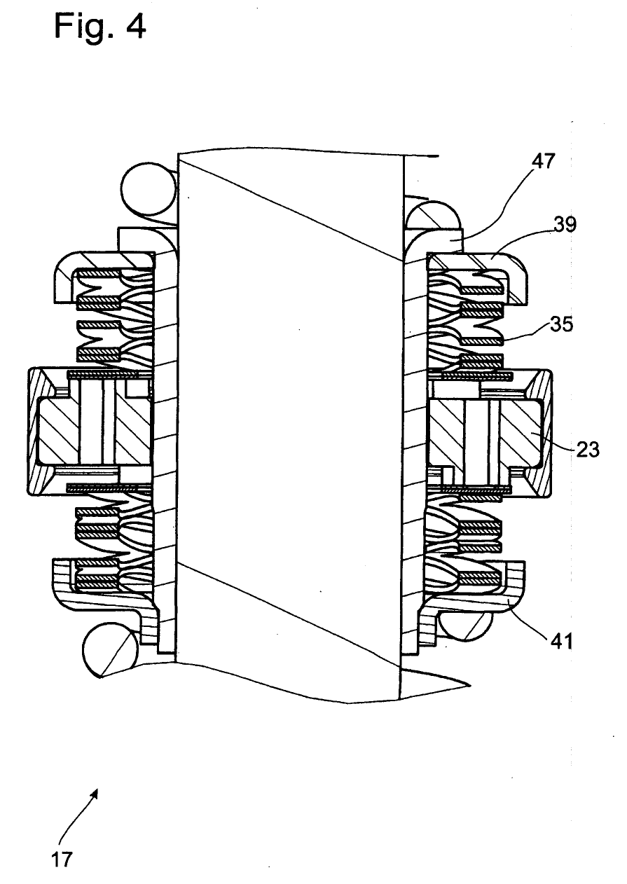

In the area between the second piston 23 and the spring plate 41, the variant of the structural unit 17 according to FIG. 4 is identical to that shown in FIG. 2. As an alternative possibility for fastening the spring plate 39, which has a U-shaped cross section as a whole, an end stop 47 acting in the pull-out direction, is used, against which the spring plate 39 is pretensioned by the spring arrangement 35. The end stop 47 is formed by an angled circumferential section of the retaining sleeve.

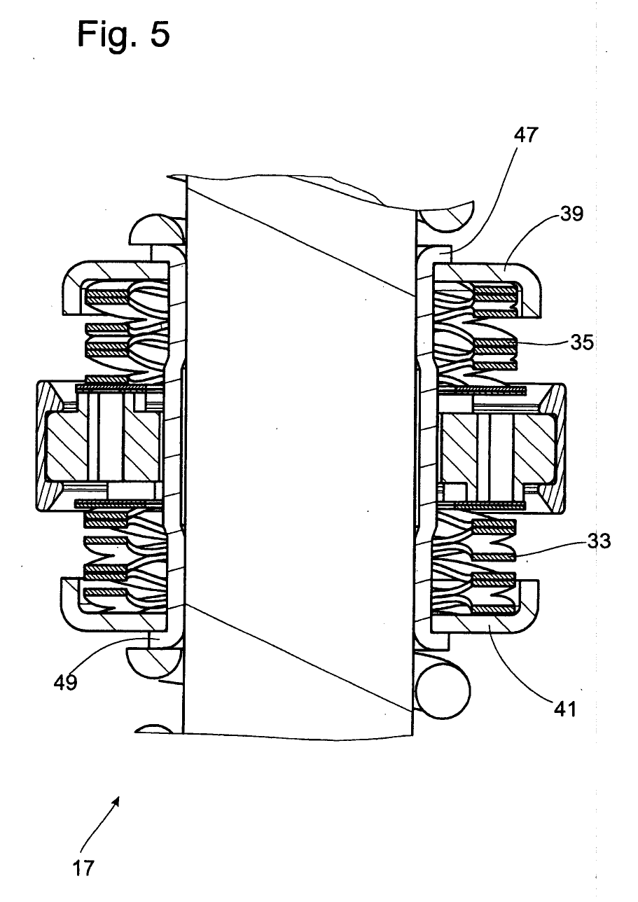

FIG. 5, moreover, shows that a U-shaped spring plate 39, 41 can be used for both spring arrangements 35, 33 in the structural unit 17. For this purpose, both end areas of the retaining sleeve are provided with an end stop 47, 49.

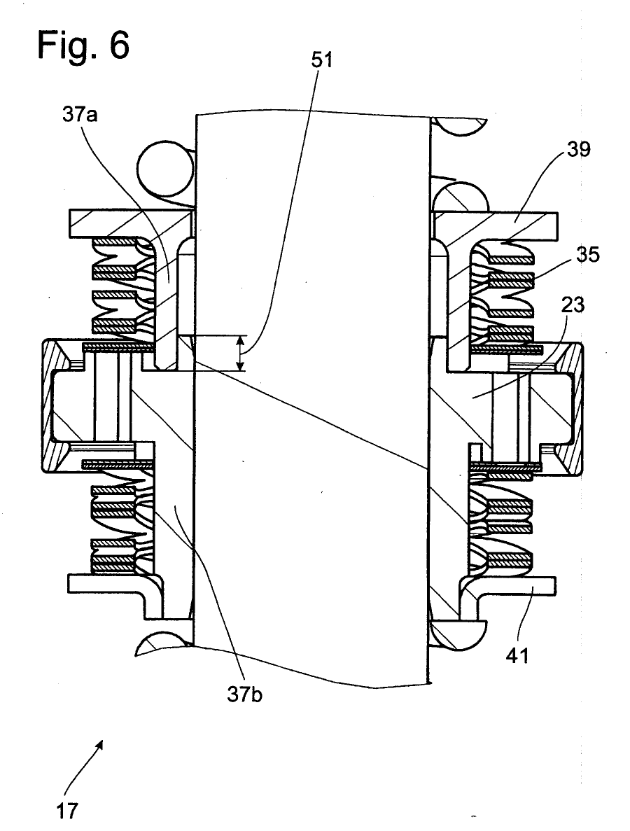

The structural unit 17 according to FIG. 6 has a retaining sleeve consisting of two retaining sleeve parts 37a; 37b, where the spring plate 39 is designed as an integral part of the retaining sleeve part 37a. The two retaining sleeve parts 37a, 37b overlap each other axially and form a press-fit in the overlapping area, where the pretension of the spring arrangement 35 can be adjusted by selecting the length of the overlapping area 51. The second piston 23 can be designed as a one-piece unit with the guide sleeve part 37b. The spring plate 41 or the end area of the guide sleeve part 37b can also be designed in the same way as the variants shown in FIGS. 2-5.

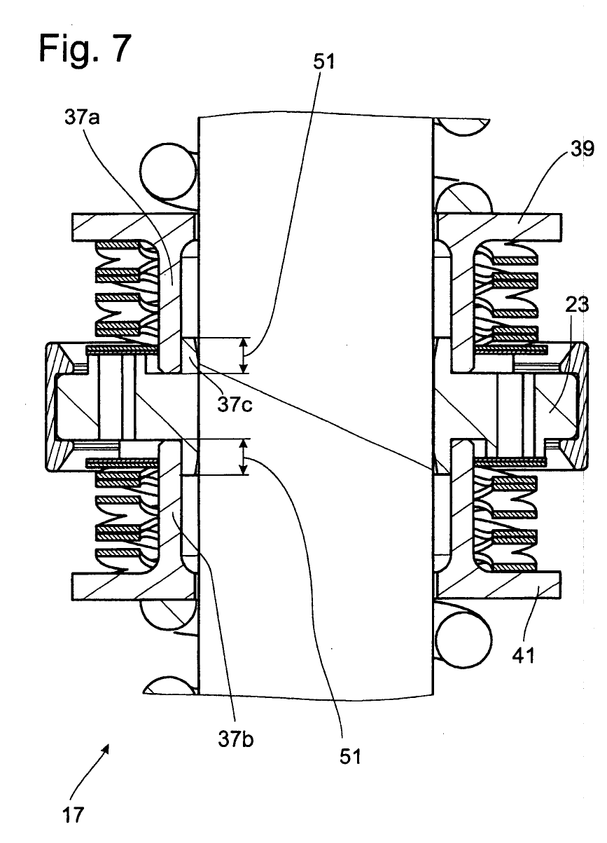

FIG. 7 shows a structural unit 17 which represents a modification of that shown in FIG. 6, in which, functionally, a three-part retaining sleeve is used. The retaining sleeve parts 37a and 37b with the spring plates 39, 41 can be identical parts. A hub 37c with a guide sleeve part on both sides is provided on the inside diameter of the second piston 23; this hub overlaps 51 and forms a press-fit with the inside diameters of the retaining sleeve parts 37a, 37b.

1.-10. (canceled)

11. A vibration damper comprising:
a cylinder;
a piston rod guided with freedom of axial movement in the cylinder;
a first piston fixed to the piston rod; and
a structural unit mounted on the piston rod with freedom of axial movement relative to the first piston against the force of at least one support spring, the structural unit comprising
a second piston equipped with at least one valve disk loaded against the second piston by a spring arrangement;
a retaining sleeve to which the second piston is fixed radially outside of the retaining sleeve; and
at least one spring plate fixed to the retaining sleeve at an axially adjustable position determined by a desired pretension in the spring arrangement, the spring arrangement being located between at least one spring plate and a respective at least one valve disk.

12. The vibration damper of claim 11 wherein the at least one spring plate is press fit onto the retaining sleeve.

13. The vibration damper of claim 12 comprising two said spring plates, wherein the retaining sleeve has an end stop against which one of said spring plates is axially loaded by a respective said spring arrangement.

14. The vibration damper of claim 13 wherein said retaining sleeve is formed with an annular flange which serves as said end stop.

15. The vibration damper of claim 11 said second piston is press fit onto said retaining sleeve.

16. The vibration damper of claim 11 comprising two said spring plates, wherein one of said spring plates is formed as one piece with said retaining sleeve.

17. The vibration damper of claim 11 wherein the retaining sleeve comprises at least two axially adjacent sections, at least one of said spring plates being formed as one piece with a respective said axial section.

18. The vibration damper of claim 17 wherein two of said sections overlap each other axially.

19. The vibration damper of claim 18 wherein at least two of said sections are press fit together.

20. The vibration damper of claim 17 wherein said second piston is formed as one piece with one of said sections.
